(19) United States
(12) Patent Application Publication
(10) Pub. No.: US 2022/0282556 A1
(43) Pub. Date: Sep. 8, 2022

(54) Universal single-channel system for destroying and marking valuables in the case of unauthorized access

(71) Applicant: Gleb Vladimirovitch LOKSHIN, Moscow (RU)

(72) Inventor: Gleb Vladimirovitch LOKSHIN, Moscow (RU)

(21) Appl. No.: 17/625,058

(22) PCT Filed: Jul. 8, 2019
(86) PCT No.: PCT/RU2019/000484

§ 371 Date: Jan. 5, 2022

(51) Int. Cl. E05G 1/14

(52) U.S. Cl. CPC E05G 1/14

(57) ABSTRACT

There is proposed a system for opening packaging, destroying and marking valuable items to render them unfit, for future use in case of unauthorized access. The system includes a receptacle storing a marking agent, connected to a control device and to at least one spraying channel connected to the inner cavity of a container storing valuable items. Disposed in the channel is a charge of a pyrotechnic or explosive substance, connected to an electric detonator coupled to the control device for activation of the system. The system provides for opening the packaging, deforming a stored object and injecting the marking agent using the channel that allows minimizing the area occupied by the system in the container storing the items and reduction of the number of structural elements, while eliminating bulky structural elements. Such design allows for using any marking agent, renders the system universal for use in various storage containers.

### CROSS-REFERENCE TO RELATED APPLICATIONS

This application is a U.S. national stage application of an international application PCT/RU2019/000484 filed on 8 Jul. 2019, published as WO2021006756.

### FIELD OF THE INVENTION

The invention relates to auxiliary devices for the protection of valuables during their storage and transportation. The device represents an automatic package opening, destruction and marking system for securities (papers, documents, bank notes, etc.) to make them useless in case of unauthorized access. It can be also used for destruction and marking of storage media of any types.

### BACKGROUND OF THE INVENTION

There is a system for marking and destruction of securities to prevent their further use (DE 102007015382 A1, E05G1/14, 2 Oct, 2008). The system comprises a vessel with a marking agent connected by a ribbed port with at least one spraying tube. The marking agent can be stored in the vessel under excessive pressure ensuring its supply to stored items. The spraying tube can be made with at least one outlet hole or port located in the immediate vicinity to the location of valuables.

A disadvantage of the known device is that it is impossible to mark or damage values in case there is a package, which restricts the use of this system. The location of the system in the immediate vicinity to the location of valuables suggest_{bI} locating the system by means of useful space in the transportation storage for valuables or in stationary storages providing such access.

There is a device for destruction of items stored in a transportation container equipped with a protective alarm and a destruction device (RU 2190075 C2, E05G1/14 27 Sep. 2014, 2002). The destruction device is made as an elongated element formed by the channel made of fiber-reinforced plastic or aluminum, with a hose made of plastic film located within it, and with a liquid dye. The dye vessel is secured in the channel by a grating, with an explosive tape located between them and the hose. The device length is the maximum length permitted by the storage container. A linear charge of penthrite (tetranitropentaerytrite) is used as the explosive, which is placed into a plastic shell, but other explosives are also permitted. When the alarm trips, the substance directly affects the items inside by opening the package and deforming them, at least partially destroying. At the same time, the explosive bursts the hose with the liquid dye and sprays it to the items to provide marking.

Due to a small impact zone, the device must be installed inside the storage near the items, e.g., by means of using the useful volume. System elements inside the storage may impede rearrangement of the papers and cause damage of the papers or the system itself.

There is a system for marking bank notes, documents and securities (RU 176952 U1, B41M3114, 02 Feb. 2018) comprising containers for a marking substance, with nozzles on one side of them, which inject the marking substance towards the stored items. Container edges accommodate plugs with a propellant charge and a fuse. The fuse is placed in chutes between the containers to open the package of valuables. The system comprises an electronic control device that activates the system and elements to attach it on the storage walls.

In case of unauthorized access to the storage, the fuse is activated and burns out to activate propellant charges located in plugs of the dye containers. Generated gaseous products discharge the dye through the nozzles. This device is adopted as the closest analog.

A disadvantage of the known device is a multitude of individual elements, in particular, containers, propellant charges, initiation assemblies, which may cause a failure to actuate, a small percentage of package opening and coloring of bank notes. Opening and coloring systems are spaced so that the package opening area and the marking area may not fully coincide. The high sensitivity of propellants suggests compliance of special storage conditions and use of this system, which may cause of failure to actuate in case of non-compliance. The known device also suggests the use of the internal useful space of the storage, while the maximum distance from the marking system to the protected items must not exceed 30 mm. Items located at a great distance from this device may remain without significant damages or may be left unmarked.

The known devices are complex in manufacturing and are meant to be placed in the internal useful space of the storage, while a small impact zone does not provide for a significant area of protective package opening and penetration of the marking substance to the items, which causes intactness of valuables after unauthorized access. Using highly sensitive substances implies further challenges in manufacturing and using them.

### BRIEF DESCRIPTION OF THE INVENTION

The invention is designed to eliminate these disadvantages of analog devices.

To achieve the technical result, a system for destruction and marking of valuables in case of unauthorized access is introduced comprising a storage vessel for the marking agent connected with the control device and at least one spray channel with at least one outlet port connected with the internal cavity of the vessel for storing valuables, whereas the spray channel accommodates a charge of propellant or explosive connected with the fuse associated with the control device that activates the system.

A distinctive feature of the system is opening the package deforming the stored item and supplying the marking substance via the same channel. This minimizes the system functioning area in the storage vessel for valuables and reduces the total number of structural elements without limiting the intended use. The capability of placing the system beyond the storage vessel secures the useful volume of the storage and provides a wide range of engineering solutions. No large structural elements and infinity of embodiments including the use of any specific marking agent make the system universal for use in storage containers of various shapes and purposes. It allows transporting various valuables in the container without modifying the design. The system is completely self-contained.

The marking agent represents a flowing matter, for example, a liquid or dry powder-like substance. The flow of the flowing matter of the marking agent is supplied to the spray tube under pressure. To this end, an excessive pressure is preliminary created in the marker storage vessel, or a gas generating compound and a fuse are installed into the vessels, which is connected to the system control device.

There is a membrane between the marking agent storage vessel and the spray channel, which is destroyed in case of pressure rise in the vessel or by propellant or explosive actuation products.

The spray channel may be located outside the storage vessel for valuables and inside it if necessary. The spray channel fulfills a double function in the system—it is used to supply propellant or explosive actuation product to the storage vessel for valuables and then to supply the marking agent. The channel configuration has no substantial significance. Any design is permitted, which can be termed as “a channel”. The system is not limited by any specific configuration of the channel. Any design of the channel is permitted provided the following conditions are met: the channel cavity is connected with the storage container for valuables, the channel cavity is connected with the internal cavity of the storage vessel for valuables, a propellant or explosive charge is located in the channel cavity.

One of the embodiments of the spray channel is the tube. The tube can have one or several outlet ports. In the case of multiple ports, they are evenly placed along the tube length.

The tubular spray channel in the storage container for valuables is placed such that the ports in the tube are oriented towards the wall of the storage vessel for valuables. Respective ports are made in the vessel wall at the same level (in parallel) whereby the vessel cavity is connected to the spray tube channel. The tube can be made with one outlet port. In this case, the edge of the tube is connected to the vessel wall that also has a port corresponding to the channel in the tube, which ensures the channel passage to the location of valuables.

Before activation, the outlet port (passage) or ports are closed by a baffle destroyed in case of pressure or temperature rise, for example, by a polymer film or paper membrane.

In the spray channel represented by a tube with ports, it is preferable to place a propellant charge, and in other cases, it is preferable to use an explosive charge. The propellant charge is distributed in the tube so that during actuation the fire force goes through all ports in the tube (nozzle) and respective ports in the vessel wall and penetrates the location of valuables opening the package and deforming the stored items. The explosive charge is located in the channel so as to ensure package opening and destroy the stored items.

The propellant charge energy can be used not only for opening and destruction but also for timely supply of various materials of substances to the location of valuables, such as a dye (marking agent) in case they fill the spray channel. In particular, the channel can be filled with individual elements such as polyurethane foam pieces or sand containing the marking agent, When the propellant charge actuates, the elements or the marker will eject towards the stored items destroying the baffle, the package and the items, which will increase the marking reliability and make them unsuitable for further use.

### DESCRIPTION OF DRAWINGS & PREFERRED EMBODIMENTS OF THE INVENTION

FIG. 1 schematically shows the system for destruction and marking of securities with package opening where the spray channel is made as a tube. A storage vessel (3) of the marking agent (4) with a gas-generating pyrotechnic charge (5), fuse (6) and control device (7) are installed in the transportation container (1) beyond the storage vessel (2) for securities. A spray channel (8) shaped as a tube and separated from the vessel (3) of the marking agent by a collapsible membrane (13) on the external side of the vessel (2) in parallel to its wall. A pyrotechnic charge (11) connected with the fuse (6) is located in the tube. The tube (8) has outlet ports (nozzles) (9) oriented towards the vessel (2) wall. Similar ports (1) are made at the level of ports (9) in the wall (2). The ports (9) in the tube (8) are closed with a thin collapsible baffle (12) such as a polymeric film.

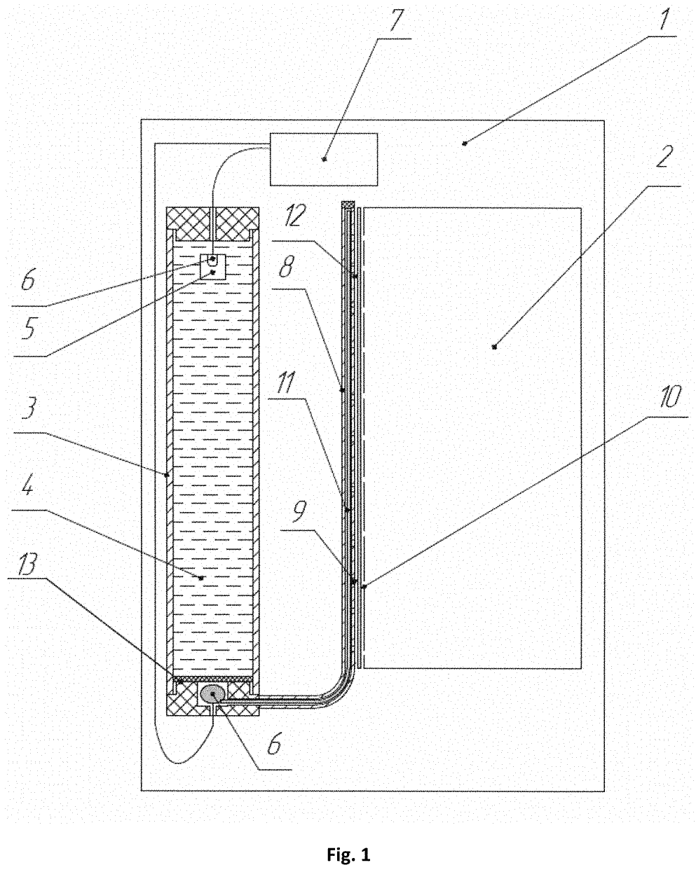

FIG. 2 schematically shows the system where the spray channel is connected in the internal cavity of the storage vessel by a single outlet port. A storage vessel (3) of the marking agent (4) with a gas-generating pyrotechnic charge (5), fuse (6) and control device (7) are installed in the transportation container (1) beyond the storage vessel (2) for securities. A spray channel (8) separated from the vessel (3) of the marking agent by a collapsible membrane (13) on the external side of the vessel (2) in perpendicular to its wall. A propellant charge connected with the fuse (6) is located in the channel (8). A port (1) corresponding to the port (9) is made at the level of the outlet port (9) in the vessel (2) wall. The channel is connected to the storage zone of valuables via the outlet port (9) oriented to the vessel (2) wall and the port (10). The port of the channel (9) is closed by the collapsible baffle (12).

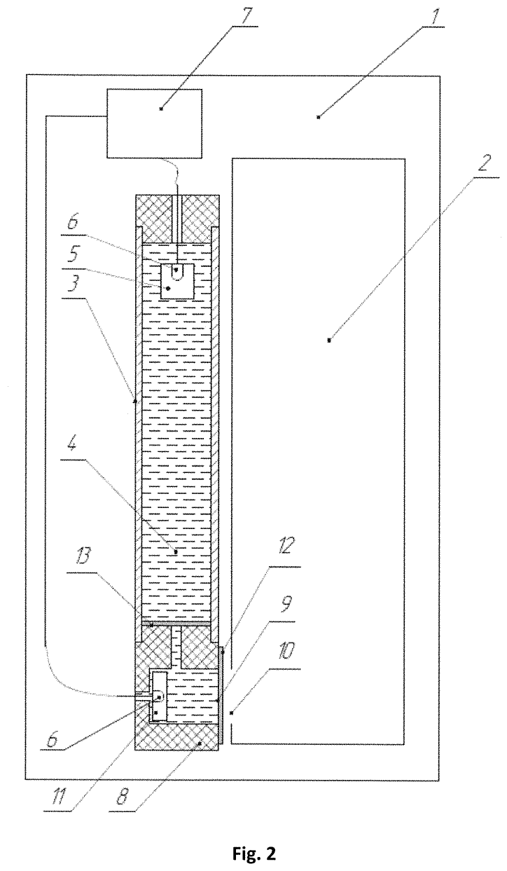

### OPERATION OF THE INVENTION

The system is an auxiliary protection device used under the control of the systems controlling access to the container. In case of an unauthorized opening of the container (1) for transportation of securities, documents or bank notes, the access control system transmits a signal to the control device (7) that activates fuses (6) that initiate the pyrotechnic (explosive) charge located in the spray channel and the gas-generating charge located in the vessel (3). Gaseous products formed as a result of the pyrotechnic charge burning (or explosion of the explosive charge) destroy the baffle (12) under high pressure and at high temperature, penetrate via the ports (9) and (10) to the storage zone and open (burn through or mechanically destroy) the existing package and deform the stored items preventing their further use.

The signal received at the second fuse (6), simultaneously or with a short delay, initiates the gas-generating charge in the marking agent vessel. The marking agent bursts the membrane (13) under the action of formed gaseous products and is supplied to the spray channel (8). The marking agent is sprayed from the channel via the opened ports (9) and (10) to the vessel into the storage zone where the stored items are marked. The marking agent is released from the vessel under pressure due to its destruction by the charge activation products in the spray channel.

In the case of several ports, their diameter and spacing are such that the areas of spraying the marking agent of neighboring ports intersect, which allows covering the areas of items to be marked as much as possible, and if there is a package, it allows covering the entire area of the deformed package, which prevents keeping non-damaged items. If there are burning out fragments after triggering of the pyrotechnic (explosive) charge, the marking agent has a fire-extinguishing effect.

In this manner, the system provides for thermal and mechanical opening of the packing material, deformation and marking of valuables. Apart from paper media, this device can also destroy and mark any types of storage media such as cassettes, discs (CD, DVD), electronic boards.

The invention is not limited by illustrated and described embodiments of the device. Possible changes within the disclosed essence of the invention are permitted.

1. A system for destruction and marking of valuables in case of unauthorized access comprising a storage vessel containing a marking agent connected with a control device and at least one spray channel with at least one outlet port connected with an internal cavity of a vessel for storing valuables, wherein the at least one spray channel accommodates a charge of propellant or explosive connected with a first fuse associated with the control device that activates the system.

2. The system according to claim 1 wherein the marking agent is located in the storage vessel under excessive pressure.

3. The system according to claim 1 wherein the storage vessel of the marking agent accommodates a gas-generating charge and a second fuse connected with the control device that activates the system.

4. The system according to claim 1 wherein the marking agent represents a flowing substance.

5. The system according to claim 4 wherein the marking agent represents a liquid or dry powder substance.

6. The system according to claim 1 wherein the spray channel is made as a tube comprising one or more outlet ports.

7. The system according to claim 6 wherein the outlet ports are oriented to the wall of the storage vessel for valuables where respective ports are made at the same level whereby the spray tube channel is connected with the internal cavity of the vessel whereas the channel accommodates a charge of the pyrotechnical agent connected with the first fuse.

8. The system according to claim 6 wherein the spray channel is connected with the internal cavity of the storage vessel for valuables by a single outlet port at which level a respective port is made in the vessel wall whereas the channel accommodates a charge of the explosive agent connected with the first fuse.

9. The system according to claim 1, wherein the at least one outlet port is closed by a collapsible baffle.

10. The system according to claim 8 wherein the spray channel is filled with the marking agent or individual elements containing the marking agent.

11. The system according to claim 1 wherein there is a membrane between the marking agent storage vessel and the spray channel, which is destroyed in case of pressure rise in the vessel or by propellant or explosive actuation products.
